(19) United States
(12) Patent Application Publication
(10) Pub. No.: US 2005/0212403 A1
(43) Pub. Date: Sep. 29, 2005

(54) Planar display structure and producing process of the same

(76) Inventors: Yaw-Ming Tsai, Taichung (TW); Shih-Chang Chang, Hsinchu (TW); An Shih, Changhua (TW); Chao-Yu Meng, Taichung (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/938,011

(22) Filed: Sep. 10, 2004

(30) Foreign Application Priority Data
Mar. 24, 2004 (TW) 093107974

(51) Int. Cl. H05B 33/14

(52) U.S. Cl. 313/498; 313/503

(57) ABSTRACT

A process for producing an active matrix organic light-emitting diode (AMOLED) display is provided. The process includes steps of providing a substrate; forming an active matrix structure having a first semiconductor layer on the substrate; and forming a driving circuit structure having a second semiconductor layer on the substrate wherein the grain size of the second semiconductor layer is larger than that of the first semiconductor layer. The planar display with improved uniform luminance generated from the process is also provided. It includes the substrate; the active matrix structure having the first semiconductor layer with smaller grain size; and the driving circuit structure having the second semiconductor with larger grain size.

### FIELD OF THE INVENTION

The present invention relates to a planar display structure and a producing process for producing the planar display structure and more particularly to an active matrix organic light-emitting diode (AMOLED) display and a producing process of the same.

### BACKGROUND OF THE INVENTION

Please refer to FIG. 1, a circuit diagram schematically showing a pixel driving circuit of a conventional active matrix organic light-emitting diode (AMOLED) display. Each pixel of the conventional AMOLED display includes two transistors and one capacitor (2T1C) wherein the gate of one of the transistors, i.e. M1, is coupled to a gate line 10 and the other two electrodes of the transistor M1 are respectively coupled to a data line 20 and the gate of the other transistor M2. The source and drain of the transistor M2 are respectively coupled to a voltage Vdd and the anode of an organic light-emitting diode (OLED). The cathode of the OLED is grounded. A storage capacitor Cs is coupled between the source and gate of the transistor M2. When the gate line 10 is activated, the transistor M1 is regarded as a closed switch. Hereat, a driving voltage is transmitted via the data line 20 and quickly stored in the capacitor Cs. Meanwhile, the driving voltage biases the transistor M2 so that a constant current Id may pass through the OLED and makes it illuminate.

As described above, the pixel driving circuit for the conventional AMOLED in FIG. 1 is driven when the driving voltage biases the transistor M2 to enable the OLED. For integrating peripheral circuits in a display, thin film transistor (TFT) produced by low temperature poly-silicon (LTPS) process is the most popular transistor used in the pixel driving circuit of OLED. However, it is so far difficult to control the grain size of the poly-silicon produced by conventional LTPS process. In practice, the threshold voltage and mobility of a TFT made from such poly-silicon often vary even if the TFTs are formed on the same substrate. Accordingly, constant driving voltage applied to the capacitor Cs does not lead to constant current for actuating the OLEDs. Thus, the variation causes a significant non-uniform problem of the panel in luminance.

### SUMMARY OF THE INVENTION

Therefore, the present invention provides a process for producing a planar display structure with improved uniform luminance.

According to one aspect of the present invention, the process includes steps of providing a substrate; forming an active matrix structure having a first semiconductor layer on the substrate; and forming a driving circuit structure having a second semiconductor layer on the substrate, wherein the grain size of the second semiconductor layer is larger than that of the first semiconductor layer.

Preferably, the first semiconductor layer is a micro-silicon layer and the second semiconductor layer is a poly-silicon layer.

In one embodiment, the thickness of the first semiconductor layer is smaller than that of the second semiconductor layer.

In one embodiment, the active matrix structure is an AMOLED structure.

In another aspect, the present invention relates to a process for producing a planar display including steps of: providing a substrate; forming a raw semiconductor layer on the substrate; and performing at least one crystallization procedure to convert at least one of a first portion and a second portion of the raw semiconductor layer into a first semiconductor layer and a second semiconductor layer, respectively. The grain size of the second semiconductor layer is larger than that of the first semiconductor layer.

Preferably, the first semiconductor layer forms thereon an active matrix structure and the second semiconductor layer forms thereon a driving circuit structure. The active matrix structure is an AMOLED structure.

Preferably, the first semiconductor layer is a micro-silicon layer and the second semiconductor layer is a poly-silicon layer.

Preferably, the thickness of the first semiconductor layer is smaller than that of the second semiconductor layer.

In one embodiment, the raw semiconductor layer is an amorphous silicon layer and the thickness of the first portion of the raw semiconductor layer is smaller than that of the second portion of the raw semiconductor layer.

In one embodiment, the raw semiconductor layer is a micro-silicon layer and the crystallization procedure is performed to convert the second portion of the raw semiconductor layer into a poly-silicon layer while keeping the first portion of the raw semiconductor layer unchanged.

In another embodiment, the raw semiconductor layer is an amorphous silicon layer with the first and second portions of equal thickness, and the crystallization procedure comprises a first crystallization procedure and a second crystallization procedure for forming the first and second portions, wherein the energy density applied to the first crystallization procedure is higher than that applied to the second crystallization procedure.

Preferably, the crystallization process comprises a Solid Phase Crystallization (SPC) process, an Excimer Laser Anneal (ELA) process or a Sequential Lateral Solidification (SLS) process.

In another aspect, the present invention relates to a planar display structure with improved uniform luminance. The structure includes a substrate; an active matrix structure formed on the substrate and having a first semiconductor layer; and a driving circuit structure formed on the substrate and having a second semiconductor layer. The grain size of the second semiconductor layer is larger than that of the first semiconductor layer.

Preferably, the first semiconductor layer is a micro-silicon layer and the second semiconductor layer is a poly-silicon layer.

In one embodiment, the active matrix structure is an AMOLED structure.

In one embodiment, the thickness of the first semiconductor layer is smaller than that of the second semiconductor layer.

Preferably, the substrate is a light-transmissible substrate.

Preferably, the substrate is made of glass, quartz or plastic.

### BRIEF DESCRIPTION OF THE DRAWINGS

The above and other objects and advantages of the present invention will become more readily apparent to those ordinarily skilled in the art after reviewing the following detailed description and accompanying drawings, in which:

FIG. 1 is a schematic diagram showing a pixel driving circuit of a conventional AMOLED display;

FIG. 2 is a cross-sectional diagram of an AMOLED panel structure according to the present invention;

FIGS. 3(a), 3(b), and 3(c) are schematic diagrams showing a producing process of a first embodiment according to the present invention;

FIGS. 4(a), 4(b), and 4(c) are schematic diagrams showing a producing process of a second embodiment according to the present invention; and

FIGS. 5(a), 5(b), and 5(c) are schematic diagrams showing a producing process of a third embodiment according to the present invention.

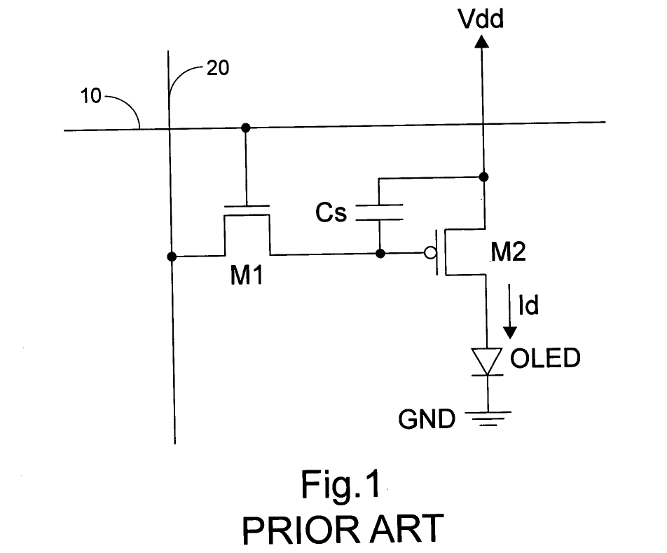

### DETAILED DESCRIPTION OF THE PREFERRED EMBODIMENT

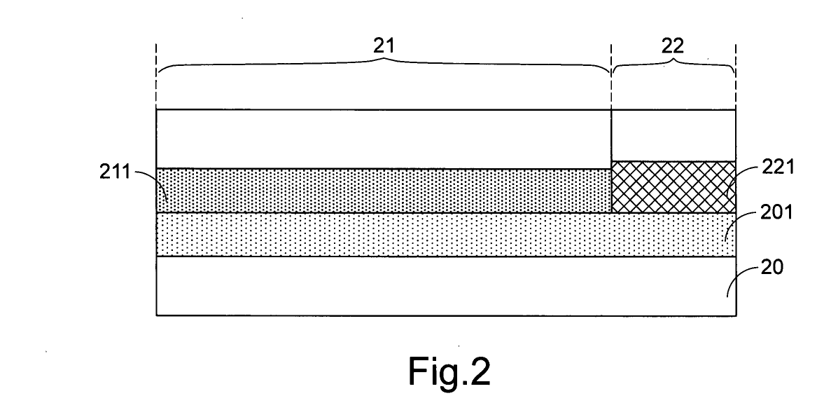

Please refer to FIG. 2, in which a cross-section of an AMOLED display panel structure according to one embodiment of the present invention is shown. The AMOLED display panel includes a substrate 20 and a buffer layer 201. An active matrix structure 21 having a first semiconductor layer 211 and a driving circuit structure 22 having a second semiconductor layer 221 are formed on the buffer layer 201. In this embodiment, the first semiconductor layer 211 and the second semiconductor layer 221 are a micro-silicon layer and a poly-silicon layer, respectively. Accordingly, the variation of threshold voltage and mobility of each TFT in the active matrix structure 21 made from micro-silicon are effectively controlled. Therefore, the problem in non-uniform luminance of the panel is thus improved. On the other hand, in order to keep better electric property and driving ability, the driving circuit structure 22 is still made from poly-silicon because it is less sensitive to the variation of threshold voltage and mobility.

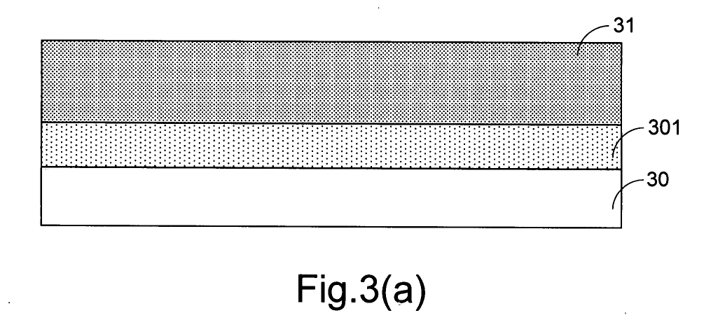

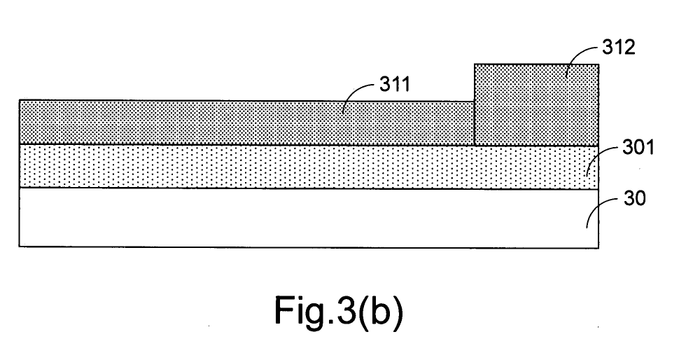

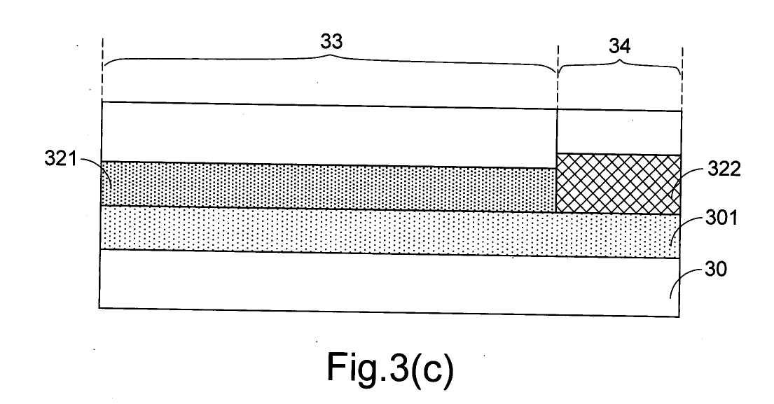

Please further refer to FIGS. 3(a), 3(b), and 3(c), which are cross-sectional diagrams schematically showing a producing process according to a first embodiment of the present invention. As shown in FIG. 3(a), a glass substrate 30 is provided at first. Then, a buffer layer 301 and a raw semiconductor layer 31 made from amorphous silicon are formed on the glass substrate 30 in sequence. As shown in FIG. 3(b), a micro-lithography and etch procedure are performed on the raw semiconductor layer 31 to define a first portion 311 and a second portion 312 wherein the thickness of the first portion 311 is smaller than that of the second portion 312. Subsequently, a laser crystallization procedure is applied to the first portion 311 and the second portion 312 of the raw semiconductor layer 31. The laser energy density should be properly controlled to entirely melt the amorphous silicon in the first portion 311. Since the second portion 312 is thicker than the first portion 311, the same laser energy density is not high enough to entirely melt the amorphous silicon in the second portion 312. That is, in the following cooling procedure, the first portion 311 is converted into a micro-silicon semiconductor layer 321 having relative small grain size and the second portion 312 is converted into a poly-silicon semiconductor layer 322 having relatively large grain size. After that, the desired active matrix structure 33 and driving circuit structure 34 are formed as shown in FIG. 3(c). The laser crystallization procedure may be performed by a Solid Phase Crystallization (SPC) process, an Excimer Laser Anneal (ELA) process or a Sequential Lateral Solidification (SLS) process.

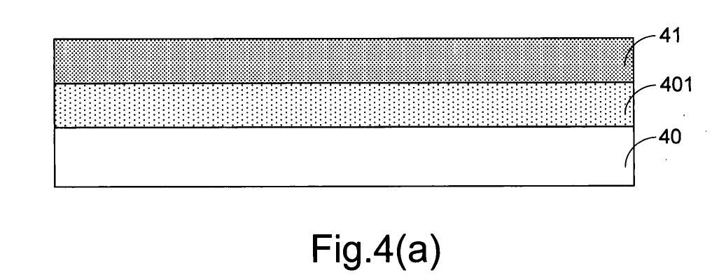

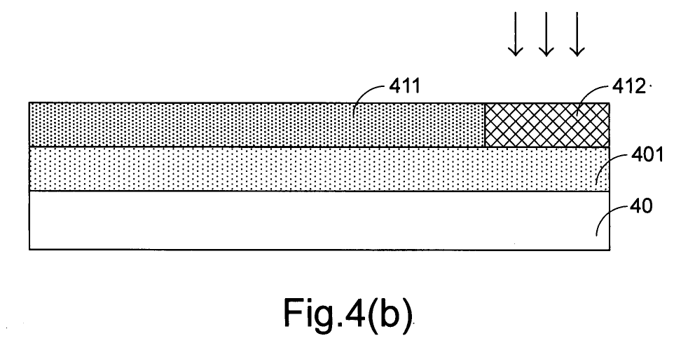

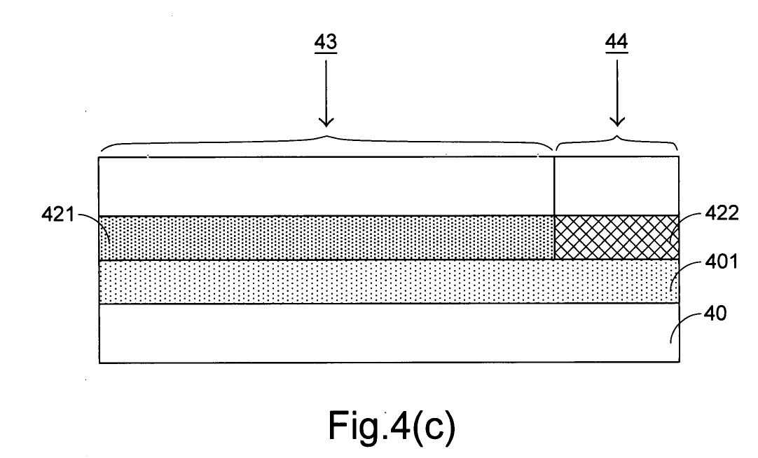

Please further refer to FIGS. 4(a), 4(b), and 4(c), which are cross-sectional diagrams schematically showing a producing process according to a second embodiment of the present invention. As shown in FIG. 4(a), a glass substrate 40 is provided at first. Then, a buffer layer 401 and a raw semiconductor layer 41 made from micro-silicon are formed on the glass substrate 40 in sequence. A laser crystallization procedure is merely applied to the second portion 412 of the raw semiconductor layer 41 indicated by the arrow in FIG. 4(b). Thus, the micro-silicon of the second portion 412 of the raw semiconductor layer 41 re-crystallizes to form poly-silicon with larger grain size. That is, the first portion 411 keeps unchanged to serve as a micro-silicon semiconductor layer 421 having relatively small grain size and the second portion 412 is converted into a poly-silicon semiconductor layer 422 having relatively large grain size. After that, the desired active matrix structure 43 and driving circuit structure 44 are formed as shown in FIG. 4(c). The laser crystallization procedure is also performed by a SPC, ELA or SLS process.

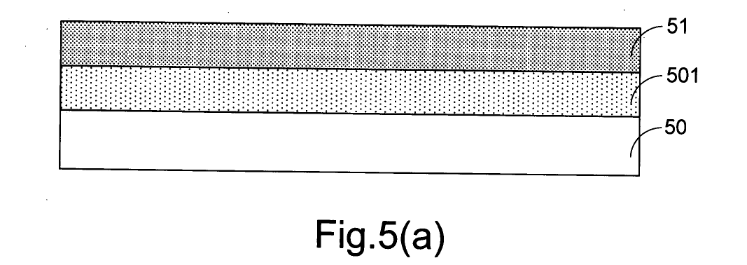

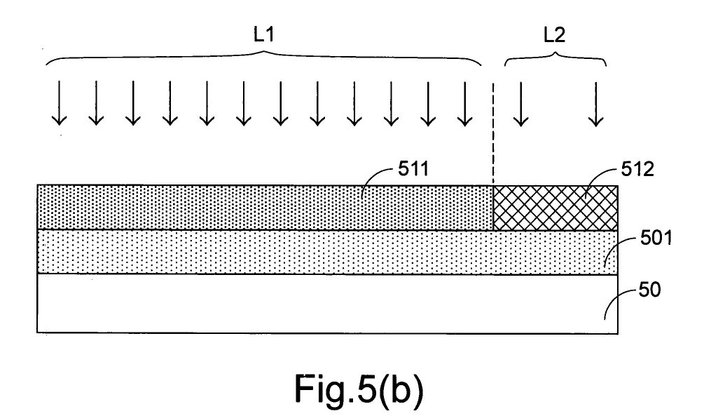

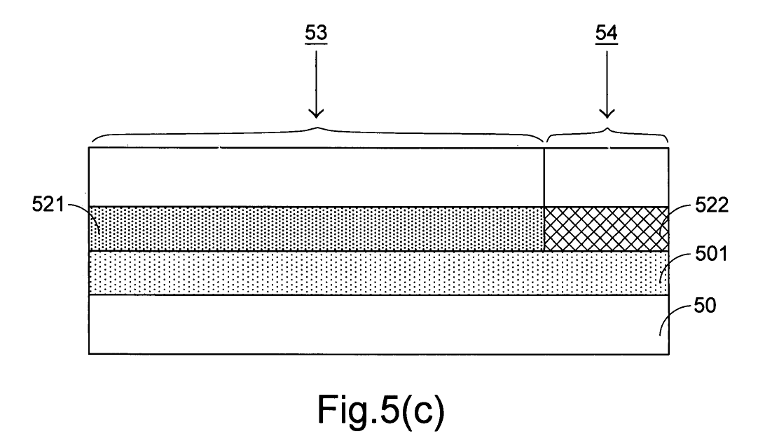

Please further refer to FIGS. 5(a), 5(b), and 5(c), which are cross-sectional diagrams schematically showing a producing process according to a third embodiment of the present invention. As shown in FIG. 5(a), a glass substrate 50 is provided at first. Then, a buffer layer 501 and a raw semiconductor layer 51 made from amorphous silicon are formed on the glass substrate 30 in sequence. As shown in FIG. 5(b), a first laser crystallization procedure L1 and a second laser crystallization procedure L2 are applied to the first portion 511 and the second portion 512 of the raw semiconductor layer 51, respectively, wherein the energy density of the first laser crystallization procedure L1 is higher than that of the second laser crystallization procedure L2. In one embodiment, the first and second producers L1 and L2 utilizes the same laser crystallization procedure except different laser energy densities are applied on respective portions 511 and 512. In another embodiment, the first and second procedures L1 and L2 utilizes two different kinds of laser crystallization procedures. For example, two producers L1 and L2 utilize ELA and SLS, respectively. Therefore the amorphous silicon in the first portion 511 entirely melts while the amorphous silicon in the second portion 512 partly melts. That is, in the following cooling procedure, the first portion 511 is converted into a micro-silicon semiconductor layer 521 having relatively small grain size and the second portion 512 is converted into a poly-silicon semiconductor layer 522 having relatively large grain size. After that, the desired active matrix structure 53 and driving circuit structure 54 are formed as shown in FIG. 5(c).

To sum up, the active matrix structure and the driving circuit structure in this invention are made from materials with different electric properties. That is, the TFT in the driving circuit structure exhibits better electric performance and driving ability, while the TFT in the active matrix structure has stabilized current driving ability. By this way, the non-uniform luminance problem of the panel can be effectively improved. The present invention can be widely applied to a variety of current-driven planar displays in stead of being limited to the OLED display described in the preferred embodiment for exemplification only.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A process for producing a planar display comprising steps of:
providing a substrate;
forming an active matrix structure having a first semiconductor layer on said substrate; and
forming a driving circuit structure having a second semiconductor layer on said substrate wherein the grain size of said second semiconductor layer is larger than that of said first semiconductor layer.

2. The process according to claim 1, wherein said first semiconductor layer is a micro-silicon layer and said second semiconductor layer is a poly-silicon layer.

3. The process according to claim 1, wherein the thickness of said first semiconductor layer is smaller than that of said second semiconductor layer.

4. The process according to claim 1, wherein said active matrix structure is an active matrix organic light-emitting diode structure.

5. A process for producing a planar display comprising steps of:
providing a substrate;
forming a raw semiconductor layer comprising a first portion and a second portion on said substrate; and
performing at least one crystallization procedure to at least one of said first portion and said second portion of said raw semiconductor layer so as to convert said first portion and said second portion into a first semiconductor layer and a second semiconductor layer, respectively, wherein the grain size of said second semiconductor layer is larger than that of said first semiconductor layer.

6. The process according to claim 5, wherein said first semiconductor layer forms thereon an active matrix structure and said second semiconductor layer forms thereon a driving circuit structure.

7. The process according to claim 6, wherein said active matrix structure is an active matrix organic light-emitting diode structure.

8. The process according to claim 5, wherein said first semiconductor layer is a micro-silicon layer and said second semiconductor layer is a poly-silicon layer.

9. The process according to claim 5, wherein the thickness of said first semiconductor layer is smaller than that of said second semiconductor layer.

10. The process according to claim 5, wherein said raw semiconductor layer is an amorphous silicon layer and the thickness of said first portion of said raw semiconductor layer is smaller than that of said second portion of said raw semiconductor layer.

11. The process according to claim 5, wherein said raw semiconductor layer is a micro-silicon layer and said crystallization procedure is performed to convert said second portion of said raw semiconductor layer into a poly-silicon layer.

12. The process according to claim 5, wherein said raw semiconductor layer is an amorphous silicon layer with said first and second portions of equal thickness, and said crystallization procedure comprises a first crystallization procedure and a second crystallization procedure for forming said first and said second semiconductor layers,
wherein the energy density applied to said first crystallization procedure is higher than that applied to said second crystallization procedure.

13. The process according to claim 5, wherein said crystallization process is one selected from the group comprising a Solid Phase Crystallization (SPC) process, an Excimer Laser Anneal (ELA) process or a Sequential Lateral Solidification (SLS) process.

14. A planar display comprising:
a substrate;
an active matrix structure formed on said substrate and having a first semiconductor layer; and
a driving circuit structure formed on said substrate and having a second semiconductor layer, the grain size in said second semiconductor layer being larger than that in said first semiconductor layer.

15. The planar display according to claim 14, wherein said first semiconductor layer is a micro-silicon layer and said second semiconductor layer is a poly-silicon layer.

16. The planar display according to claim 14, wherein said active matrix structure is an active matrix organic light-emitting diode structure.

17. The planar display according to claim 14, wherein the thickness of said first semiconductor layer is smaller than that of said second semiconductor layer.

18. The planar display according to claim 14, wherein said first semiconductor layer and said semiconductor layer have the same thickness, and said second semiconductor layer is a poly-silicon layer converted from a micro-silicon layer by means of a crystallization procedure.

19. The planar display according to claim 14, wherein said first semiconductor layer and said semiconductor layer have the same thickness, and said second semiconductor is a poly-silicon layer converted from a amorphous silicon layer by means of a crystallization procedure having energy larger than that applied on said first semiconductor layer.
